(19) United States
(12) Patent Application Publication
(10) Pub. No.: US 2018/0097704 A1
(43) Pub. Date: Apr. 5, 2018

(54) DETERMINING RECEPTIVENESS TO A NEW COMMUNICATION

(71) Applicant: International Business Machines Corporation, Armonk, NY (US)

(72) Inventors: James E. Carey, Rochester, MN (US); Bradley L. Manning, Rochester, MN (US); Drew C. Varner, Rochester, MN (US); Charles J. Volzka, Rochester, MN (US)

(21) Appl. No.: 15/283,529

(22) Filed: Oct. 3, 2016

(51) Int. Cl. H04L 12/24

(52) U.S. Cl. CPC H04L 41/147; H04L 41/142

(57) ABSTRACT

A computer implemented method may include identifying activities of a receiving computer system during a first time period (current activities) based on a review of at least computer software applications executing on the receiving computer system during the first time period. The method may also include retrieving historical data associated with the receiving computer system, the historical data including at least amounts of time for the receiving computer system to respond to electronic messages during a second time period and pertaining to activities similar to the current activities. The method may also include calculating, via an automated statistical technique, a receptiveness value for the receiving computer system in light of the historical data and the current activities. Further, the method may include transmitting computer instructions for displaying the receptiveness value in a privacy preserving manner.

### BACKGROUND

The present disclosure relates to communication, and more specifically to determining receptiveness to an electronic communication.

### SUMMARY

The present invention provides a computer implemented method, system, and computer program product to determine receptiveness to an electronic communication. The method may include identifying activities of a receiving computer system during a first time period (current activities) based on a review of at least computer software applications executing on the receiving computer system during the first time period, where the receiving computer system is a potential recipient of at least one electronic message. The method may also include retrieving historical data associated with the receiving computer system, where the historical data includes at least amounts of time for the receiving computer system to respond to electronic messages during a second time period, where the second time period precedes the first time period (past electronic messages), and where the historical data pertains to activities similar to the current activities. The method may also include calculating, via an automated statistical technique, a receptiveness value for the receiving computer system in light of the historical data and the current activities, where the receptiveness value indicates openness of the receiving computer system to interruption during the first time period. The method may also include transmitting computer instructions for displaying the receptiveness value in a privacy preserving manner.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 presents a flowchart, according to various embodiments.

FIG. 2 presents a flowchart, according to various embodiments.

FIG. 3 depicts a schematic diagram outlining a computer system, according to various embodiments.

FIG. 4 presents a flowchart, according to various embodiments.

FIG. 5 depicts a cloud computing environment, according to various embodiments.

FIG. 6 depicts abstraction model layers, according to various embodiments.

FIG. 7 depicts a sample computer system, according to various embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present disclosure relates to electronic communication, and more specifically to determining receptiveness to an electronic communication (e.g., messaging). While the present disclosure is not necessarily limited to such applications, various aspects of the disclosure may be appreciated through a discussion of various examples using this context.

The present invention provides a computer implemented method, system, and computer program product to determine receptiveness to a communication. Aspects of the present disclosure are directed toward determining a numerical value, herein a receptiveness value, to represent the openness of a receiver (a user who is a potential recipient of a communication) and the receiver's computer system, herein a receiving computer system, to a communication. In various embodiments, the receptiveness value indicates the receiving computer system's, and the corresponding receiver's, openness to interruption at the current time. In various embodiments the receptiveness value is a number, where a high number indicates high receptiveness and a low number indicates low receptiveness (e.g., a value between 1 and 10), or vice versa. In various embodiments, the receptiveness value is a percentage. This information may be displayed to a sender (a user who is a potential sender of a communication) and their computer system, herein a sending computer system, who may then decide whether or not to initiate contact based on the receiving computer system's current openness to the interruption.

In various embodiments, a sending computer system sends a communication to a receiving computer system. In other various embodiments, a sending computer system does not send a message to a receiving computer system. For instance, a sending computer system may determine, after reviewing a receiving computer system's receptiveness value, to send a communication to the receiving computer system. In other instances, a sending computer system may determine, after reviewing a receiving computer system's receptiveness value, to decline sending a communication to the receiving computer system.

According to various embodiments, the receptiveness value may be a general value or may be specific to each sending computer system. A general receptiveness value may be the same for any sending computer system. A specific receptiveness value may be evaluated individually for each sending computer system. For example, the sender may be working on a project with the receiver therefore the receiver would be more available for that specific sender than with other senders and would therefore have a specific receptiveness value assigned to the specific sender.

To determine the receptiveness value, the receiving computer system's current activity and historical factors (described herein) may be evaluated to create a single numerical value that represents how disruptive a new communication session would be for the receiver and the receiving computer system. In various embodiments, current activity are activities of the receiving computer system at the current time. Historical data may be activities and factors of the receiving computer system at a past time. The receptiveness value may correlate the current activity state along with historical data for similar activity states.

In various embodiments, historical data is further weighted against the current activity. For example, consistently long response delays whenever a particular application is open may be more heavily weighted than just the level of activity in that program. In various embodiments, the receiver is prompted or has available means to provide feedback to indicate their level of openness to a particular chat. This data may be used to verify or re-weight previous factors to better represent the receiver's openness over time. High levels of activity, terse responses, and long response delays may indicate a lowered availability for new communication sessions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources by may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

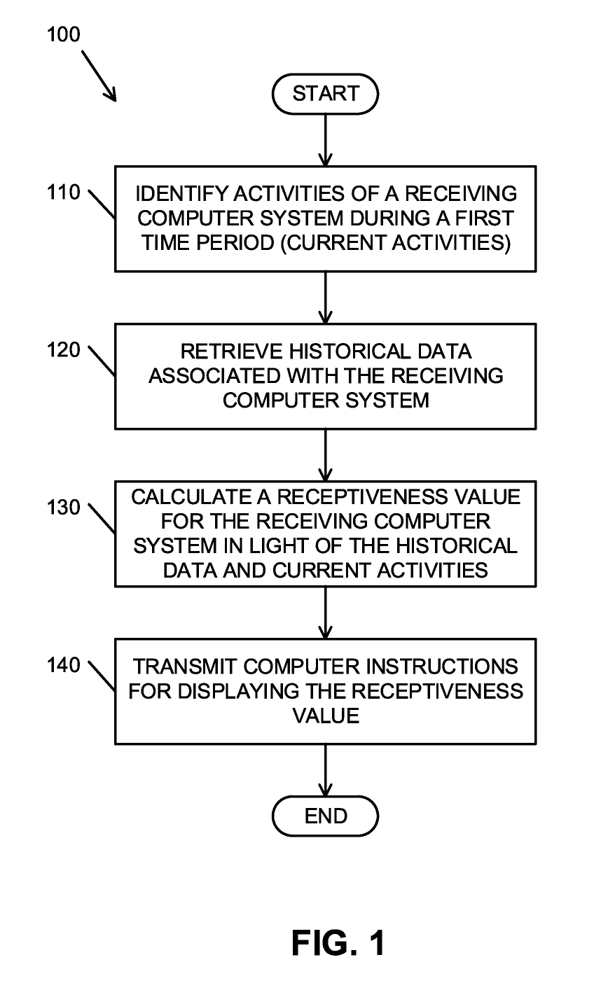

Referring now to FIG. 1, a flowchart illustrating a method 100 for determining a receptiveness value is depicted, according to various embodiments. In an embodiment, the method 100 is implemented as a computer script or computer program to be executed on a computer system such as computer system 700. In an embodiment, a computer system is configured to execute operation 110 to identify activities of a receiving computer system during a first time period (current activities). In various embodiments, current activities include computer software applications (e.g., web browsers, word processors, media players, games, email, spreadsheets, and programming/coding software), rate of keystrokes, mouse activity, active window swapping, attentiveness, and/or other computer tasks. In various embodiments, identifying current activities includes at least identifying current computer software applications executing on the receiving computer system.

In various embodiments, attentiveness is the degree of attention of a user, usually towards an application. For example, a receiver monitoring and checking an application periodically may be more attentive than a receiver running an application without monitoring the application. In various embodiments, attentiveness may also include the visibility of an application and whether or not the receiver is focused on the application. Applications that are in use by the receiving computer system may be referred to as active applications. For example, a receiving computer system may have an application visible on screen or the receiving computer system may have an application minimized. When multiple applications are being used, one application may be visible while other applications may be minimized or out of view behind applications that are more actively being used.

In an embodiment, a computer system is configured to execute operation 120 to retrieve historical data associated with the receiving computer system. In various embodiments, historical data includes information about past electronic communications (e.g. electronic messages) sent by the receiving computer system and/or content of the past electronic communications.

Information about past electronic communications may include length of time between receipt of the communication and initial reply communication (response time). In various embodiments, response time is reviewed in regards to specific applications opened at the time of the reply communication, applications in the foreground of the receiving computer system (e.g. applications visible on the screen), and/or the time of day. For example, a receiving computer system may have a shorter length of time between receipt of the communication and the initial reply (short response time) when a web browser is in the foreground of the computer system and may have a longer response time when a word processor is in the foreground of the computer system. As an additional example, a receiving computer system may have a faster response time before 10:00 AM and may have a slower response time between 1:00 PM and 3:00 PM on a given day.

In various embodiments, content of past electronic communications includes the length of the reply communication and/or the tone of the reply communication. The length of a communication may be measured by the distance from start to end, the amount of content (e.g. words) in the communication, or other methods to measure length. In various embodiments, the tone of a communication includes the sentiment, mood, or general character of the communication. The tone of a communication may be measured by natural language processing, keyword searching, analyzing letter case (e.g., searching for numerous capital letters), searching for emoticons, or by other methods of text analysis.

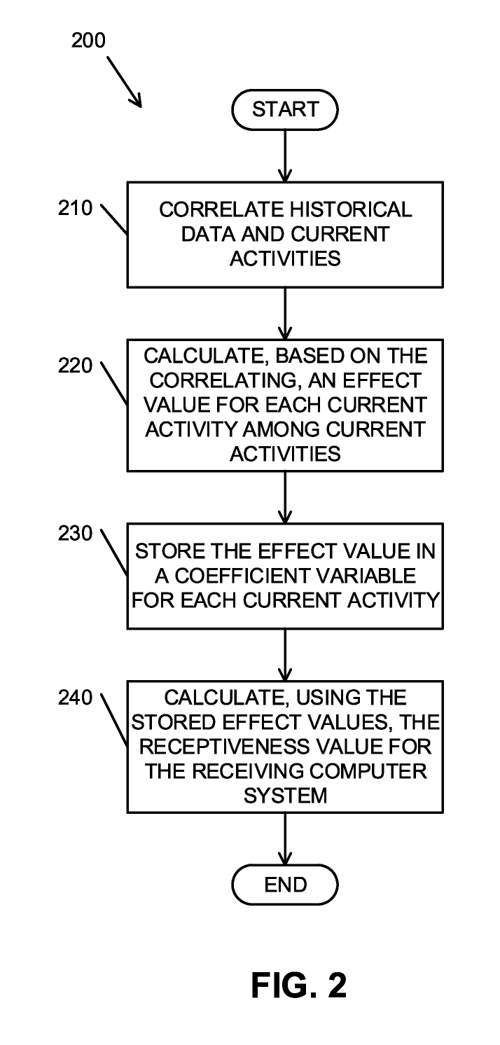

In an embodiment, a computer system is configured to execute operation 130 to calculate a receptiveness value for the receiving computer system in light of the historical data and current activities. In various embodiments, the calculating is done using an automated statistical technique. This calculation is further outlined in FIG. 2.

In an embodiment, a computer system is configured to execute operation 140 to transmit computer instruction for displaying the receptiveness value. Many types of electronic communication, for example instant messaging, include a status for the user. This status, herein traditional status, may inform other users about the user's current availability or activity and may be commonly represented by a general status such as available, away, a statement of current activity, or simply by a color (e.g., green, yellow, red). In various embodiments, the transmitted instructions may display the receptiveness value in addition to a traditional status. For example, a receiver may have a traditional status indicating availability but a receptiveness value indicating that the receiver is not open to interruption. In another example, a receiver and receiving computer system may have a traditional status indicating that the receiver is on the phone, but still may have a high receptiveness value because historically the receiver has been positively responsive to communications during similar calls. In various embodiments, the instructions to display the receptiveness value are transmitted in a way to protect the privacy of the receiving computer system and the receiver. In various embodiments, the transmitted instructions display the receptiveness value in a user friendly manner. A user friendly manner may include color, shapes, scales, descriptive words, or other visually appealing formatting.

In various embodiments, the receiving computer system is configured to receive the receptiveness value from the receiver. A receiver may be able to manually input a receptiveness value, which may then be received by the receiving computer system. As discussed herein, a receptiveness value may be transmitted as a general value, or a value specific to a sending computer system or group of sending computer systems. In various embodiments, a general receptiveness value may be a value that is attributed to all sending computer systems.

In various embodiments, when a receptiveness value is specific to a sending computer system or group of sending computer systems, a computer system is further configured to identify electronic communication exchanged between the receiving computer system and at least one sending computer system based on a review of the historical data. For example, a user may have a short response time when communicating with a manager. In response to reviewing historical data in terms of the specific sending computer system(s), a second receptiveness value may be calculated for the specific sending computer system(s), in various embodiments. Instructions for displaying the second receptiveness value may then be transmitted to the specific sending computer system(s).

In various embodiments, operations 110, 120, 130, and 140 of method 100 may all be performed by the receiving computer system. This may preserve the privacy of the receiving computer system as potentially private data may not be sent to the sending computer system. In these embodiments, the receptiveness value may be the only information sent to the sending computer system(s).

In various embodiments, operations 110, 120, 130, and 140 of method 100 may all be performed by a computer system of a trusted third party. In various embodiments, a third party computer system is involved to factor in additional information. Additional information may include metrics such as the receiver's job title, work hours, and other information that may not be available to the receiving computer system. For example, a receiving computer system may not have access to the receiver's vacation schedule, but a third party may be able to obtain permission to access this information. Third party processing may also allow for meta-analysis of many receivers to identify additional patterns. Examples may include, programmers not favoring interruptions while development applications are open, managers being less open to interruption during meetings, and subordinates being available to a direct manager's communication.

In various embodiments, additional information may also include external device activity such as smart phones or Internet of Things connected devices. In various embodiments, these external devices are located using the receiving computer system or a third party computer system. The external devices may be in the same room as the receiver and the receiving computer system. In various embodiments, the current activity of these devices is identified. For example, a coffee pot may be brewing a cup of coffee, therefore the coffee pot would be identified as active or running. In various embodiments, after identifying the current activity, the current activity of the external devices is correlated, or combined, with the current activity and historical data identified for the receiving computer system. This data may then be used to calculate the receptiveness value of the receiving computer system. In various embodiments, the external devices and the receiving computer system are all connected via the Internet of Things. The current activity and other data may be exchanged between devices, primarily between the external devices and the receiving computer system, using the Internet of Things.

In various embodiments, use of a third party computer system may help protect the privacy of a receiver from potential senders and sending computer systems. Without a third party server, the receiver may need to broadcast the receptiveness value for each sender. For example, an employee may be consistently more open to communication with one co-worker over another. Because the receptiveness value is based on historical data and current activity, this may inadvertently leak a receiver's relative openness to one individual (sender) over another. Using a third party server may allow the receiver to inform the server about all potential sender's receptiveness values, but a specific sender may only be able to query the server for its specific receptiveness value.

In various embodiments, a computer system is further configured to gather information available from other devices and include this information in operations 110, 120, 130, and 140. Other devices may include a television, coffee pot, cell phone, tablet, thermostat, or any electronic device. In various embodiments, this processing is done by a third party computer system. The third party system may work with the receiving computer system to gather the data necessary for the other devices. For example, a receiving computer system may know what devices are nearby but the third party may not know what devices are close to the receiving computer system, so the receiving computer system may have to communicate this information to the third party computer system. In various embodiments, these devices and their corresponding data may be included in the current activities and historical data as well as the calculation of the receptiveness value. For example, a user may have a television on in the room which may lengthen the response time of a communication. The television and its corresponding data may be included as a current activity which may then be included in the calculation of the receptiveness value.

In various embodiments, a computer system is further configured to receive feedback data relating to accuracy of the receptiveness value. The receiver may have an option to input feedback indicating the accuracy of their calculated receptiveness value. For example, a receiver may have a receptiveness value indicating high receptiveness but is actually very busy reading a document and is not receptive to communication. The receiver may give feedback indicating that the receptiveness value was not accurate. Feedback may include surveys, ratings, or other methods of indicating accuracy. In various embodiments, a sender, and the corresponding sending computer system, has the option to input feedback.

In various embodiments where feedback is inputted, feedback data may be used to calculate a value indicating the accuracy of the receptiveness value (accuracy value). In various embodiments, an accuracy value indicating low accuracy is used to adjust the automated statistical technique used to calculate the receptiveness value. For example, feedback may indicate that the receptiveness value is not accurate therefore the calculation may be adjusted to help increase accuracy for future receptiveness value calculations.

Referring to FIG. 2 a flowchart of a method 200 for calculating a receptiveness value is depicted, according to various embodiments. In an embodiment, the method 200 is implemented as a computer script or computer program to be executed on a computer system such as computer system 700. In various embodiments, the method 200 is included in operation 130 of method 100. In various embodiments, the method 200 is executed via a cloud computing system.

In an embodiment, a computer system is configured to execute operation 210 to correlate historical data and current activities. In various embodiments, correlating includes gathering historical data and current activity data. For example, a list of all visible application on a receiving computer screen, as well as the active application may be gathered. A list of their titles may then be made. In various embodiments, the historical data and current activity data may be cleaned up and condensed in this step (operation 210). Continuing with the previous example, the application titles may have to be cleaned up to remove information related to the document that's open, so that only the type of window is captured. “textfile.text—Notepad” may become “Notepad” in this example, where “Notepad” may refer to Microsoft® Notepad.

In an embodiment, a computer system is configured to execute operation 220 to calculate, based on the correlating, an effect value for each current activity among current activities. In various embodiments, the effect value varies in association with the active application. Continuing with the previous example, each application title may be assigned an effect value of 1, while the active application may be assigned an effect value of 10.

In various embodiments, when an effect value may already exist for an application, the new assigned effect value may be combined with the preexisting effect value. In various embodiments, the combination may include adding or subtracting effect values. For example, “Notepad” may have had a preexisting effect value of 1, and has now been assigned an effect value of 10. The two effect values may be added together, causing “Notepad” to have a calculated effect value of 11. In various embodiments, historical data may be used to determine how multiple effect values assigned to an application should be combined. For example, if historical data showed that a receiver was less receptive to communication when using “Notepad,” the new assigned effect value of 10 may be subtracted from the preexisting effect value of 1, which leads to a calculated effect value of −9. In this specific example, negative values and subtraction correspond to a lower availability and receptiveness, but other examples may be vice versa.

In an embodiment, a computer system is configured to execute operation 230 to store the effect value in a coefficient variable for each current activity. In various embodiments, the effect value is a coefficient of the corresponding application. Continuing the earlier example, “Notepad” with a calculated effect value of 11 would read “11 Notepad” where 11 is the coefficient corresponding to “Notepad.” In various embodiments, these effect value coefficients and application names are inserted into a table.

In an embodiment, a computer system is configured to execute operation 240 to calculate, using the stored effect values, the receptiveness value for the receiving computer system. In various embodiments, this calculation is done using an automated statistical technique. In various embodiments, the statistical technique includes combining the tabulated effect value coefficients to determine a total effect value, and allocating total effect values (or a range of total effect values) with receptiveness values. For example, a table of effect value coefficients may read:

11 “Notepad”

1 Mozilla Firefox®

1 Windows® Command Processor (Command Prompt)

10 Microsoft® Visual Studio® Debugger

In this example, these coefficients may be added together to get a total effect value of 23. A range of total effect values from 20-30 may be assigned to a receptiveness value indicating that the receiver is moderately available (e.g., a receptiveness value of 3 from a scale of 1 to 10). In various embodiments, the active application may be multiplied by a large factor. In various embodiments, positive and negative values may be used to indicate varying degrees of receptiveness.

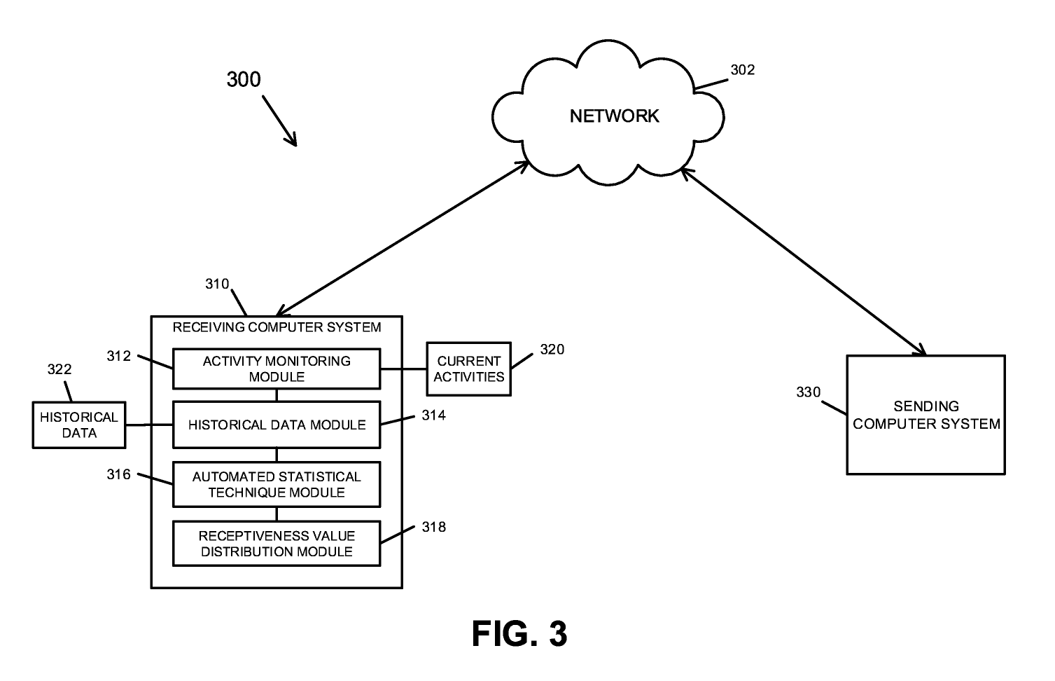

Referring to FIG. 3, system 300 includes computer systems and connections for determining a receptiveness value, according to various embodiments. System 300 is only one possible arrangement of connecting computer systems.

In various embodiments, receiving computer system 310 includes an activity monitoring module 312, a historical data module 314, an automated statistical technique module 316, and a receptiveness value distribution module 318. Although the receiving computer system 310 is depicted herein with certain elements and implementations, the receiving computer system 310 is not limited to these elements and implementations. In various embodiments, the activity monitoring module 312 is configured to identify the current activities 320 of a receiving computer system. In various embodiments, the historical data module 314 is configured to retrieve historical data 322 associated with the receiving computer system. In various embodiments, the historical data 322 is stored on a computer memory. The automated statistical technique module 316 may be configured to calculate a receptiveness value for the receiving computer system 310. In various embodiments, the receptiveness value distribution module 318 is configured to transmit computer instructions for displaying the receptiveness value for the receiving computer system 310. In various embodiments, modules 312, 314, 316, and 318 are implemented as computer programs configured to be executed on a computer system such as computer system 700. In various embodiments, modules 312, 314, 316, and 318 are implemented as computer systems such as computer system 700.

In various embodiments, system 300 includes a receiving computer system 310, a network 302, and a sending computer system 330. Although the system 300 depicts one receiving computer system 310 and one sending computer system 330, any number of receiving computer systems 310 and sending computer systems 330 may be connected. In various embodiments, network 302 connects receiving computer system 310 to sending computer system 330. In various embodiments, receiving computer system 310 and sending computer system 330 are connected via a cloud computing system.

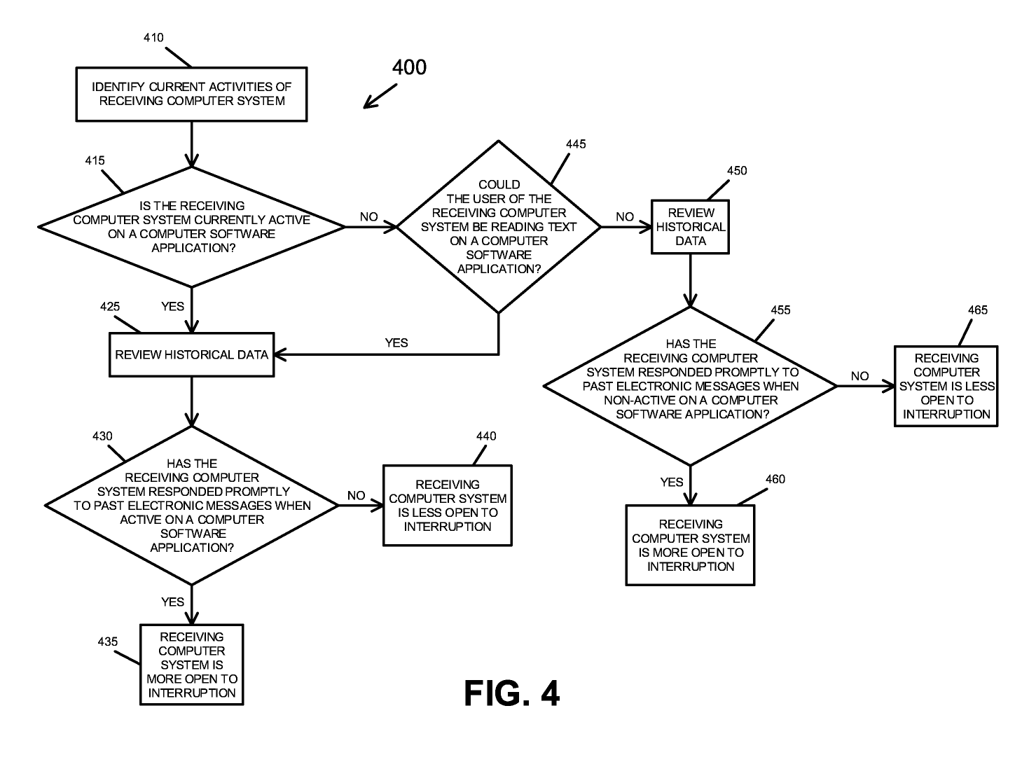

Referring to FIG. 4 a flowchart outlining a method 400 of determining openness to interruption is depicted, according to various embodiments. In an embodiment, the method 400 is implemented as a computer script or computer program to be executed on a computer system such as computer system 700. The method 400 is only one example of determining openness to interruption.

In an embodiment, a computer system is configured to execute operation 410 to identify current activities of a receiving computer system. In various embodiments, operation 410 corresponds with operation 110 of FIG. 1. In an embodiment, a computer system is configured to execute operation 415 to determine the activity of the receiving computer system. In various embodiments, the receiving computer system may be currently active on a computer software application or may not be currently active on a computer software application.

In operation 445, the receiving computer system is not currently active on a computer software application, therefore it may then be determined whether a user was reading text. In an embodiment, a computer system is configured to execute operation 445. In various embodiments, the user of the receiving computer system (receiver) may or may not be reading text on a computer software application. When the user is reading text, the receiving computer system may be treated as currently active on a computer software application, and method 400 may proceed to operation 425.

In operation 425, the receiving computer system is currently active on a computer software application, therefore historical data may then be reviewed. In an embodiment, a computer system is configured to execute operation 425. In various embodiments, operation 425 corresponds with operation 120 of FIG. 1. Following the review of historical data 425, operation 430 may determine the response time of the receiver when active on a computer application. In an embodiment, a computer system is configured to execute operation 430. In various embodiments, the receiver and the corresponding receiving computer system may or may not have responded promptly to past electronic messages when active on a computer software application. In various embodiments, operation 435 occurs where the receiving computer system has responded promptly to past electronic messages when active on a computer software application, therefore the receiving computer system may be more open to interruption. In operation 440, the receiving computer system has not responded promptly to past electronic messages when active on a computer software application, therefore the receiving computer system may be less open to interruption.

In operation 445, it may be determined by the computer system that the user of the receiving computer system cannot be reading text on a computer software application. In operation 450, after determining that the user of the receiving computer system cannot be reading text, historical data may be reviewed by the computer system. In an embodiment, a computer system is configured to execute operation 450. In various embodiments, operation 450 corresponds with operation 120 of FIG. 1.

Following the review of historical data 450, a computer system executing operation 455 may determine the response time of the receiver when non-active on a computer application. In various embodiments, the receiver and the corresponding receiving computer system may or may not have responded promptly to past electronic messages when non-active on a computer software application. In operation 460, the receiving computer system has responded promptly to past electronic messages when non-active on a computer software application, therefore the receiving computer system may be more open to interruption. In operation 465, the receiving computer system has not responded promptly to past electronic messages when non-active on a computer software application, therefore the receiving computer system may be less open to interruption.

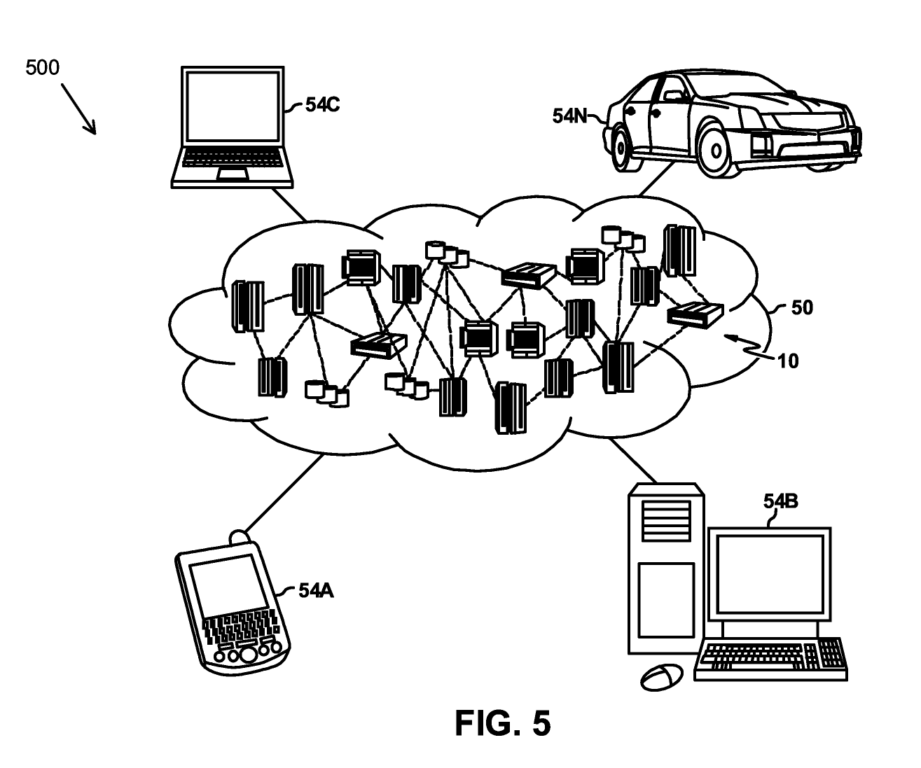

FIG. 5 depicts an illustrative cloud computing environment 500. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

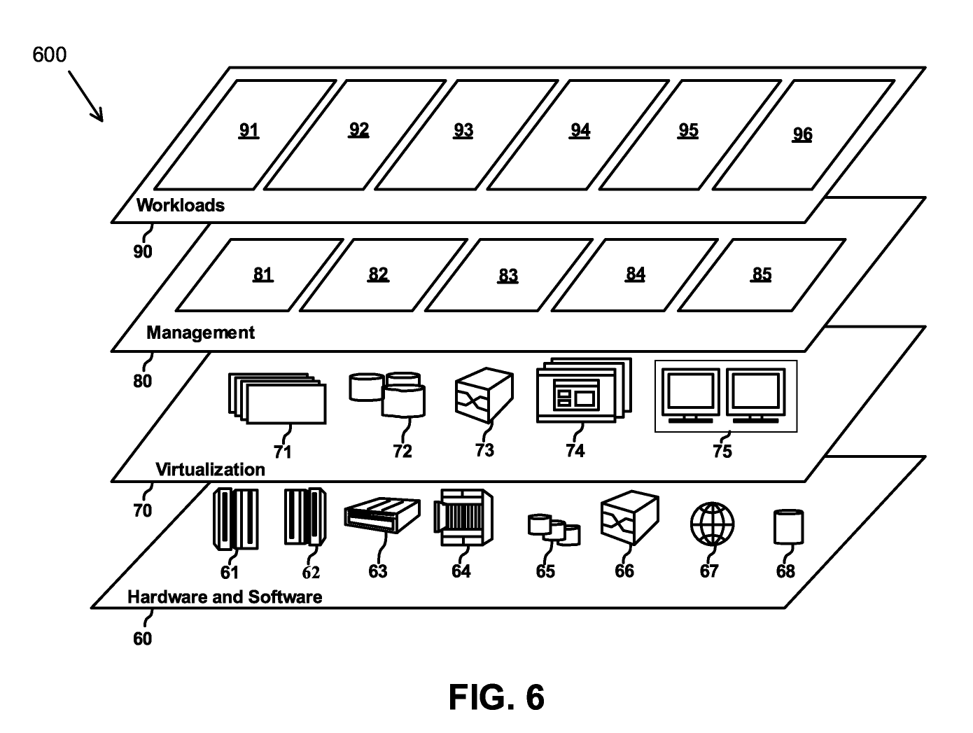

FIG. 6 is a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and communication processing 96.

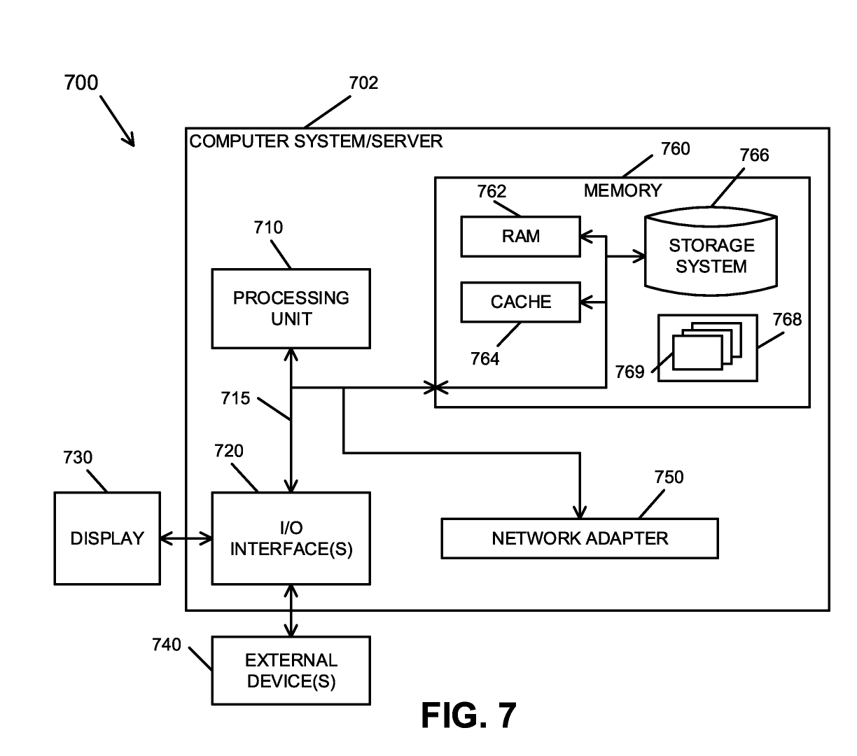

FIG. 7 shows an exemplary embodiment of a computer system, computer system 700. Computer system 700 is only one example of a computer system and is not intended to suggest any limitation as to the scope of use or functionality of embodiments of the present invention. Regardless, computer system 700 is capable of being implemented to perform and/or performing any of the functionality/operations of the present invention.

Computer system 700 includes a computer system/server 702, which is operational with numerous other general purpose or special purpose computing system environments or configurations. Examples of well-known computing systems, environments, and/or configurations that may be suitable for use with computer system/server 702 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 702 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 702 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 702 in cloud computing node 700 is shown in the form of a general-purpose computing device. The components of computer system/server 702 may include, but are not limited to, one or more processors or processing units 710, a system memory 760, and a bus 715 that couple various system components including system memory 760 to processor 710.

Bus 715 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 702 typically includes a variety of computer system readable media. Such media may be any available media that is accessible by computer system/server 702, and it includes both volatile and non-volatile media, removable and non-removable media.

System memory 760 can include computer system readable media in the form of volatile memory, such as random access memory (RAM) 762 and/or cache memory 764. Computer system/server 702 may further include other removable/non-removable, volatile/non-volatile computer system storage media. By way of example only, storage system 766 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 715 by one or more data media interfaces. As will be further depicted and described below, memory 760 may include at least one program product having a set (e.g., at least one) of program modules that are configured to carry out the functions of embodiments of the invention.

Program/utility 768, having a set (at least one) of program modules 769, may be stored in memory 760 by way of example, and not limitation, as well as an operating system, one or more application programs, other program modules, and program data. Each of the operating system, one or more application programs, other program modules, and program data or some combination thereof, may include an implementation of a networking environment. Program modules 769 generally carry out the functions and/or methodologies of embodiments of the invention as described herein.

Computer system/server 702 may also communicate with one or more external devices 740 such as a keyboard, a pointing device, a display 730, etc.; one or more devices that enable a user to interact with computer system/server 702; and/or any devices (e.g., network card, modem, etc.) that enable computer system/server 702 to communicate with one or more other computing devices. Such communication can occur via Input/Output (I/O) interfaces 720. Still yet, computer system/server 702 can communicate with one or more networks such as a local area network (LAN), a general wide area network (WAN), and/or a public network (e.g., the Internet) via network adapter 750. As depicted, network adapter 750 communicates with the other components of computer system/server 702 via bus 715. It should be understood that although not shown, other hardware and/or software components could be used in conjunction with computer system/server 702. Examples, include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electronic signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object orientated program language such as Smalltalk, C++, or the like, and procedural programming languages, such as the “C” programming language or similar programming languages. The computer readable program instructions may execute entirely one the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method comprising:
identifying activities of a receiving computer system during a first time period (current activities) based on a review of at least computer software applications executing on the receiving computer system during the first time period, wherein the receiving computer system is a potential recipient of at least one electronic message;
retrieving historical data associated with the receiving computer system, wherein the historical data comprises at least amounts of time for the receiving computer system to respond to electronic messages during a second time period, wherein the second time period precedes the first time period (past electronic messages), and wherein the historical data pertains to activities similar to the current activities;
calculating, via an automated statistical technique, a receptiveness value for the receiving computer system in light of the historical data and the current activities, wherein the receptiveness value indicates openness of the receiving computer system to interruption during the first time period; and
transmitting computer instructions for displaying the receptiveness value in a privacy preserving manner.

2. The method of claim 1, wherein the calculating comprises:
correlating the historical data and the current activities;
calculating, based on the correlating, an effect value for each current activity among the current activities, wherein the effect value indicates an effect of the each current activity on an amount of time for the receiving computer system to respond to the at least one electronic message during the first time period;
storing the effect value in a coefficient variable for the each current activity, resulting in effect values stored in coefficient variables corresponding to the current activities; and
calculating, using the stored effect values, the receptiveness value for the receiving computer system.

3. The method of claim 1, further comprising:
receiving feedback data relating to accuracy of the receptiveness value;
calculating, based on the feedback data, an accuracy value of the receptiveness value, wherein the accuracy value indicates accuracy of the receptiveness value; and
adjusting, based on the accuracy value, the automated statistical technique.

4. The method of claim 1, wherein the current activities comprise at least one of the computer software applications executing on the receiving computer system, keystrokes occurring on the receiving computer system, mouse activity occurring on the receiving computer system, and the attentiveness of the receiving computer system.

5. The method of claim 1, wherein the historical data comprises information about the past electronic messages and content of the past electronic messages.

6. The method of claim 1, further comprising:
locating one or more external devices in a room of the receiving computer system;
identifying current activity of the one or more external devices; and
correlating the current activity of the one or more external devices with the historical data and current activity.

7. The method of claim 1, wherein the receptiveness value is attributed to a plurality of sending computer systems, wherein each of the plurality of sending computer systems is a potential sender of the electronic message to the receiving computer system.

8. The method of claim 1, wherein the receptiveness value is specific to at least one sending computer system.

9. The method of claim 8 further comprising:
identifying electronic messages exchanged between the receiving computer system and the at least one sending computer system during a third time period between the first time period and the second time period (recent electronic messages), based on a review of the historical data;
calculating, based on the recent electronic messages and the computer software applications running on the receiving computer system, a second receptiveness value that indicates openness of the receiving computer system to interruption during the first time period with respect to the at least one sending computer system; and
transmitting computer instructions for displaying the second receptiveness value in a privacy preserving manner to the at least one sending computer system.

10. The method of claim 1, wherein at least the identifying, the retrieving, the calculating, and the transmitting are performed by the receiving computer system.

11. The method of claim 1, wherein at least the identifying, the retrieving, the calculating, and the transmitting are performed by a computer system of a trusted third party.

12. A system comprising:
a memory; and
a processor in communication with the memory, the processor configured to perform a method comprising:
identifying activities of a receiving computer system during a first time period (current activities) based on a review of at least computer software applications executing on the receiving computer system during the first time period, wherein the receiving computer system is a potential recipient of at least one electronic message;
retrieving historical data associated with the receiving computer system, wherein the historical data comprises at least amounts of time for the receiving computer system to respond to electronic messages during a second time period, wherein the second time period precedes the first time period (past electronic messages), and wherein the historical data pertains to activities similar to the current activities;
calculating, via an automated statistical technique, a receptiveness value for the receiving computer system in light of the historical data and the current activities, wherein the receptiveness value indicates openness of the receiving computer system to interruption during the first time period; and
transmitting computer instructions for displaying the receptiveness value in a privacy preserving manner.

13. The system of claim 12, wherein the calculating comprises:
correlating the historical data and the current activities;
calculating, based on the correlating, an effect value for each current activity among the current activities, wherein the effect value indicates an effect of the each current activity on an amount of time for the receiving computer system to respond to the at least one electronic message during the first time period;
storing the effect value in a coefficient variable for the each current activity, resulting in effect values stored in coefficient variables corresponding to the current activities; and
calculating, using the stored effect values, the receptiveness value for the receiving computer system.

14. The system of claim 12, wherein the method further comprises:
receiving feedback data relating to accuracy of the receptiveness value;
calculating, based on the feedback data, an accuracy value of the receptiveness value, wherein the accuracy value indicates accuracy of the receptiveness value; and
adjusting, based on the accuracy value, the automated statistical technique module.

15. The system of claim 12, wherein the receptiveness value is specific to at least one sending computer system.

16. The system of claim 15, wherein the method further comprises:
identifying electronic messages exchanged between the receiving computer system and the at least one sending computer system during a third time period between the first time period and the second time period (recent electronic messages), based on a review of the historical data;
calculating, based on the recent electronic messages and the computer software applications running on the receiving computer system, a second receptiveness value that indicates openness of the receiving computer system to interruption during the first time period with respect to the at least one sending computer system; and
transmitting computer instructions for displaying the second receptiveness value in a privacy preserving manner to the at least one sending computer system.

17. The system of claim 12, wherein at least the identifying, the retrieving, the calculating, and the transmitting are performed by a computer system of a trusted third party.

18. A computer program product comprising a computer readable storage medium having program instructions embodied therewith, the program instructions executable by a processor to cause the processor to perform a method comprising:
identifying activities of a receiving computer system during a first time period (current activities) based on a review of at least computer software applications executing on the receiving computer system during the first time period, wherein the receiving computer system is a potential recipient of at least one electronic message;
retrieving historical data associated with the receiving computer system, wherein the historical data comprises at least amounts of time for the receiving computer system to respond to electronic messages during a second time period, wherein the second time period precedes the first time period (past electronic messages), and wherein the historical data pertains to activities similar to the current activities;
calculating, via an automated statistical technique, the receptiveness value for the receiving computer system in light of the historical data and the current activities, wherein the receptiveness value indicates openness of the receiving computer system to interruption during the first time period; and
transmitting computer instructions for displaying the receptiveness value in a privacy preserving manner.

19. The computer program product of claim 18, wherein the method further comprises:
correlating the historical data and the current activities;
calculating, based on the correlating, an effect value for each current activity among the current activities, wherein the effect value indicates an effect of the each current activity on an amount of time for the receiving computer system to respond to the at least one electronic message during the first time period;
storing the effect value in a coefficient variable for the each current activity, resulting in effect values stored in coefficient variables corresponding to the current activities; and
calculating, using the stored effect values, the receptiveness value for the receiving computer system.

20. The computer program product of claim 18, wherein the method further comprises:
receiving feedback data relating to accuracy of the receptiveness value;
calculating, based on the feedback data, an accuracy value of the receptiveness value, wherein the accuracy value indicates accuracy of the receptiveness value; and
adjusting, based on the accuracy value, the automated statistical technique.
